(19) United States
(12) Patent Application Publication
(10) Pub. No.: US 2008/0027599 A1
(43) Pub. Date: Jan. 31, 2008

(54) AUTONOMOUS VEHICLE AND SYSTEMS AND METHODS FOR THE OPERATION THEREOF

(75) Inventors: James D. Logan, Candia, NH (US); Matthew Vestal, Keene, NH (US); David Northup, Jeffrey, NH (US)

Correspondence Address: FRANCIS EDWARD MARINO, 394 MEREDITH NECK ROAD, MEREDITH, NH, 03253, US

(73) Assignee: James D. Logan, Candia, NH (US)

(21) Appl. No.: 11/829,384

(22) Filed: Jul. 27, 2007

Related U.S. Application Data
(60) Provisional application No. 60/820,767, filed on Jul. 28, 2006.

(51) Int. Cl. G05D 1/00

(52) U.S. Cl. 701/23

(57) ABSTRACT

Systems and methods for providing one-way rides by autonomous vehicles are disclosed. An exemplary embodiment of the invention operates as a personal ski lift that includes an autonomous snowmobile or all terrain vehicle for providing a low-cost and flexible means to ascend ski-able terrain to bring a skier to a high-altitude skiing destination, so that the skier may depart the vehicle and ski down the terrain independent from the vehicle. The vehicle of the exemplary embodiment may meanwhile travel autonomously to a lower-altitude rendezvous point to meet the skier upon completion of his skiing. Other embodiments within the invention for providing one-way rides by various types of vehicles for various purposes are disclosed.

### RELATED APPLICATION

This application claims the benefit of U.S. Provisional Application No. 60/820,767, filed Jul. 28, 2006. The entire teachings of the referenced application are incorporated herein by reference.

### FIELD OF THE INVENTION

This invention relates to systems and methods for autonomous vehicle operation. More particularly, the invention relates to systems and methods for enabling autonomous travel and maneuvering of a vehicle, such as a snow-traversing vehicle, from a location of departure of a rider to a destination location for enabling a meeting between the vehicle and the rider at the destination location, thereby enabling independent travel of the rider, such as by skiing, snowboarding, or other method, from the departure location to the destination location, and having the vehicle at the meeting location and ready for another such round trip. While the invention is much broader in scope and is adaptable to many other uses, the principal embodiment disclosed herein applies the invention to what one might call a “personal ski lift”.

### BACKGROUND OF THE INVENTION

Skiing in powder snow has always been a highly sought after, if somewhat challenging, experience for many skiers. With today's new high-performance skis, which now allow most capable skiers to ski in powder snow, the demand for powder skiing is greater than ever. A quest for greater challenges is also increasing the popularity of glade skiing where the skier maneuvers through trees and where the powder lasts the longest and added challenges are provided by the presence of trees.

The helicopter and Sno-Cat™ skiing industry in the West have grown quite rapidly in response to the desire to ski in untracked snow. Traditional, fixed-location ski lifts are not well suited for powder skiing, as fresh powder can only be skied on once after which it is considered packed powder. Powder skiers thus need to roam over larger land areas. Therefore, vehicles are used to get people up slopes and across large areas. These vehicles tend to be expensive. For example, a “snowbus” capable of holding ten persons can cost over $80,000. They also effectively demand that groups of ten or more ski together as a group thereby reducing skiing flexibility and forcing the group to ski at the speed of its slowest member. Of course, a driver is also required.

In Canada, an operator offers snowmobile powder skiing using a snowmobile that tows a sled carrying four skiers. While lower cost than a Sno-Cat, it still remains a service that needs a driver for every four skiers. Furthermore, skiers must again coordinate their skiing with the driver to meet at the vehicle after each run.

It becomes clear, therefore, that—except for the exceptionally fit and adventurous who are willing to hike to remote areas—skiers who wish to go powder skiing away from traditional resorts have must do so subject to substantial limitations and in reliance on the assistance of a driver or other operator. Accordingly, to allow the sport of powder skiing to grow to its full potential, a more decentralized, personal, and affordable means of ascending slopes is required.

### SUMMARY OF THE INVENTION

With knowledge of the foregoing, the present inventors have created systems and methods for enabling autonomous vehicle operation. Particular embodiments of the invention can operate as what can be termed a personal ski lift (PSL) that can provide a low-cost and flexible means to ascend ski-able terrain that will allow for powder and tree skiing on greatly expanded swaths of terrain. It will take skiers past the confines of using fixed lifts at ski resorts and free them from the restrictions and costs associated with skiing at heli-skiing and Sno-Cat resorts. The personal ski lift would be usable by most skiers with little or no training beyond what is needed to operate a snowmobile. It would allow individuals to ski alone or in small groups with no lift operator or driver.

These and further objects and advantages of embodiments of the invention will become obvious not only to one who reviews the present specification and drawings but also to one who has an opportunity to make use of an embodiment of the instant invention as the personal ski lift disclosed herein. However, it will be appreciated that, although the accomplishment of each of the foregoing objects in a single embodiment of the invention may be possible and indeed preferred, not all embodiments will seek or need to accomplish each and every potential object and advantage. Nonetheless, all such embodiments taught and or encompassed by the appended claims should be considered within the scope of the present invention.

### BRIEF DESCRIPTION OF THE DRAWINGS

Many aspects of the invention can be better understood with reference to the appended drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a schematic representation of an exemplary autonomous vehicle adapted for operation as a personal ski lift,

FIG. 2 is a schematic representation of an exemplary vehicle using GPS guidance for autonomous navigation,

FIG. 3 is a schematic representation of an exemplary vehicle using recognition of RFID tags embedded in a trail for autonomous navigation,

FIG. 4 is a schematic representation of an exemplary vehicle using sensors to locate and follow a buried signal wire for autonomous navigation,

FIG. 5 is a schematic representation of an exemplary vehicle using sensors to locate and follow a pair of differently transmitting signal wires for autonomous navigation there-between,

FIG. 6 is a schematic representation an exemplary vehicle using cameras and optical recognition software for autonomous navigation,

FIG. 8 illustrates an exemplary user interface for a system according to the invention,

FIG. 9 is a schematic representation of an exemplary steering mechanism for a vehicle according to the invention, and

FIG. 10 is a schematic representation of a second exemplary steering mechanism for a vehicle according to the invention.

### DETAILED DESCRIPTION OF THE INVENTION

It will be appreciated that the systems and methods for autonomous vehicle operation described herein can pursue widely varied embodiments. However, to ensure that one skilled in the art will be able to understand and, in appropriate cases, practice the present invention, certain preferred embodiments of the broader invention revealed herein are described below and shown in the accompanying drawing figures. Before any particular embodiment of the invention is explained in detail, it must be made clear that the following details of construction, descriptions of geometry, and illustrations of inventive concepts are mere examples of the many possible manifestations of the invention.

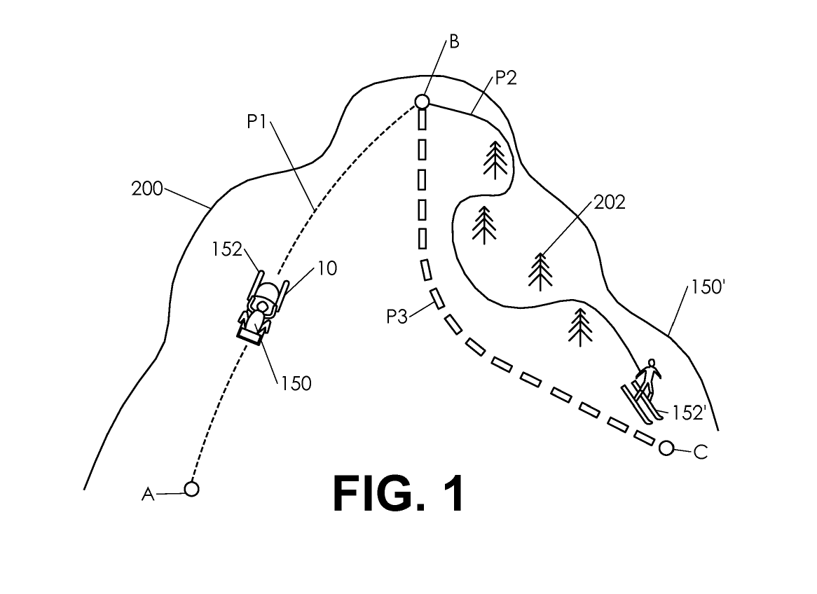

With reference to FIG. 1 where the autonomous vehicle is adapted for operation as a personal ski lift, the system could be founded on a vehicle 10 that is capable of traveling over snow. As such, the vehicle 10 could, for example, comprise an all terrain vehicle (ATV) or a snowmobile, which has been perfected to transport people over snow. Essentially stated, the system enables an autonomous travel and maneuvering of the vehicle 10 from a location of departure of a person 150 to a destination location for enabling a meeting between the vehicle 10 and the rider or person 150. With this, the system can enable independent travel of the rider 150, such as by skiing, snowboarding, or other method, from the departure location to the destination location.

In the example of FIG. 1, the person 150 can begin by riding on the vehicle 10 at an initiation point “A”, possibly with his or her skis 152 or other gear stowed on the vehicle 10. Following outgoing path P1, the person 150 can drive the vehicle 10 to location of departure “B” where the rider 10 can depart from the vehicle 150. The initiation point “A” could, for example, comprise a location on or adjacent to a mountain 200 or other potentially skiable terrain, and the departure location “B” could comprise a higher position on the mountain or other area. Once at the departure location “B”, the rider 150 can apply his or her skis 152 or other travel gear. As indicated at 150′, the rider can traverse the mountain wearing his or her skis 152′, such as along individual travel path P2, from the departure location “B” to a destination location “C” independently of the vehicle 10. Pursuant to the invention, the vehicle 10 can travel and maneuver autonomously along autonomous travel path P3 from the departure location “B” to the destination location “C” thereby to meet the rider 150 and to enable further travel of the rider 150 on the vehicle 10.

As will be described further herein, paths P1, P2, and P3 could be entirely different from one another as in FIG. 1. Alternatively, two or more of paths P1, P2, and P3 can overlap or possibly be substantially identical. For example, by methods disclosed herein, the vehicle 10 could autonomously retrace all or a portion of the outgoing path P1 as its autonomous travel path P3. Alternatively, the vehicle 10 could travel a predetermined autonomous travel path P3, or the vehicle could trace the individual travel path P2. Still further, the vehicle 10 could devise its own autonomous travel path P3. Similarly, under practices of the invention, points “A” and “C” could be spaced from one another. Alternatively, points “A” and “C” could be substantially coincident with one another in other practices of the invention.

With this, a skier 150 could drive a snowmobile vehicle 10 up the hill or mountain 200 and, upon arrival at the top, direct the snowmobile 150 to descend and meet at the bottom of the slope. The skier 150 could then ski down the slope, rendezvousing with the vehicle 10 at the bottom, and ride back up again—all without the need for a dedicated driver as is commonly required under the prior art. Passengers could ride on the back of the snowmobile 10 or be carried in a snow-sled behind the vehicle 10. In essence, the snowmobile 10 would return to the bottom of the hill empty in the same way a chairlift chair does, however, it would then wait at the bottom for its rider or riders 150 and then start the process over again.

With this, one would have the ultimate in personal freedom, namely being able to ski at his or her own pace anywhere the snowmobile 10 could go. The cost would be a small fraction of the cost of a snowbus, and no driver would be required. The vehicle 10 would result in the first true self-service means to ascend a hill or mountain, as chairlifts, rope tows and other lifts all require operators, and traditional snow vehicles require drivers to make round trips as they cannot get down by themselves. The vehicle 10 as disclosed herein extends the mega-trends seen in so many other industries—personalization, machine miniaturization, and self-service—to the skiing industry.

Alternative Vehicles and Uses

As alluded to previously, the vehicle 10 could comprise any vehicle effective for traveling over the surface at hand, whether it by snow, ice, water, dry land, or any other surface or combination thereof. Furthermore, although skiing an snowboarding are referenced herein, innumerable other activities including hiking, running, cycling, swimming, and the like could also be facilitated by exploitation of the invention. For example, in many applications, an All-Terrain Vehicle (ATV) could operate as the vehicle 10 by being provided with autonomous operation capabilities as disclosed herein. If the snow became too deep for a standard ATV, the vehicle 10 could be equipped with continuous treads in place of tires. Snow depth could also be confronted by packing a trail that the ATV 10 would take to the bottom of the hill 200. Such a trail could be packed by a snowmobile, a Sno-Cat™, or other such snow-traversing vehicle. Alternatively, the ATV 10 could travel a trail or road to the bottom that had been plowed to some degree to make it passable.

For the purposes of this disclosure, an all-terrain vehicle (ATV) is a vehicle capable of ascending and descending snow-covered slopes and for traversing unimproved terrain.

As noted, in addition enabling skiers to access non-lift serviced terrain, vehicles 10 pursuant to the invention could be used for any other application where a vehicle 10 might need to rendezvous with its driver 150. For instance, some mountain bike riders like to ride to the top of hills and mountains while others ride chairlifts and merely enjoy the trip down. The autonomous vehicle 10 disclosed herein could provide uphill transportation for such enthusiasts.

The vehicle 10 could facilitate other travel. For example, in the case of a home with a particularly long driveway, an older child could ride an ATV 10 or other vehicle as taught herein to the end of the driveway. The child could get on the bus and “send” the ATV 10 home. In the afternoon, the child could invoke the unit's “come to me” command described further herein-below to direct the vehicle 10 to follow the prescribed path to the bus stop where the child could access the vehicle 10.

Furthermore, in a working environment, an ATV 10 or other vehicle with an attached trailer or other means for transporting goods and equipped with the PSL's auto-return capability could be used to transport material in a repetitive fashion. For example, one worker could load the trailer and send it to another worker at a different location at the work site who would then unload the vehicle and return it.

In another example, a worker in a large car lot could ride an ATV 10 or other vehicle to a distant second vehicle. Upon reaching the second vehicle, the vehicle 10 could be sent back to another location where it could be accessed later.

It should also be noted, in substantially any application, a vehicle 10 could be set up to allow for automation of both the outbound and return trips. For example, in a skiing application, the vehicle 10 could travel autonomously uphill as well as downhill to accommodate users who might not wish to drive the snowmobile 10 up the hill.

Navigation Means:

There are several proposed methods under the present invention for enabling a vehicle 10 to navigate autonomously. Certain presently preferred methods are discussed individually below, but it will be appreciated that alternative methods may be within the scope of the invention. Most methods would utilize a microprocessor and some type of feedback device. The navigated course could be maintained using, for example, a control loop utilizing methods such as proportional-integrative-derivative or fuzzy logic. Kalman filters or other sensor fusion methods could be implemented in cases where multiple sensors would be used for odometry and positional feedback.

GPS-based Navigation

Technology for following a preset course using GPS devices is well known and could be used as a method to navigate autonomously. A major benefit of a GPS-based navigation system is that the infrastructure otherwise required for establishing a fixed course could be eliminated. In addition, a GPS means would be advantageous in giving the person 10 maximum flexibility to ski or otherwise traverse different terrain since the vehicle 10 would not be restricted to traveling pre-defined autonomous travel paths P3.

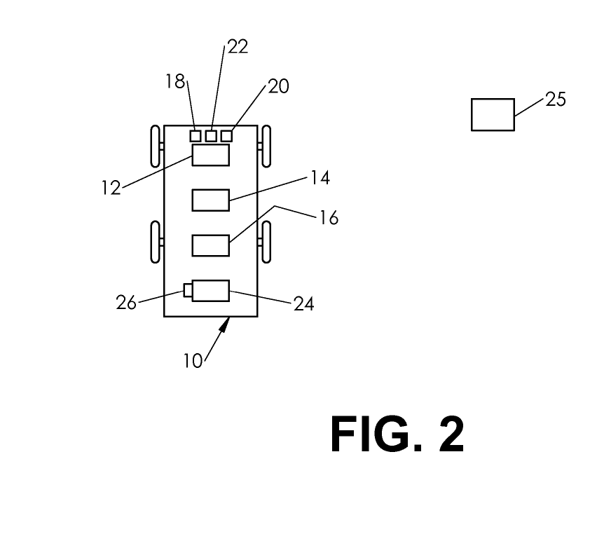

GPS routes delineating the autonomous travel path P3 could be created in several ways. The autonomous travel path P3 could be specified on a digitized map before the trip with map generating coordinates that the vehicle 10 would then follow. With further reference to FIG. 2 where the vehicle 10 is depicted schematically, such mapping could be done by a GPS receiver 14 interacting with a map displayed on a display means 12 on the vehicle 10 itself. Alternatively or additionally, mapping could be done on a remote device 25 with the resulting coordinates being downloaded to a navigation system 16 of the vehicle 10. Alternatively, the data points could be communicated, real-time, to the vehicle 10 from a remote source, such as the remote device 25, if the vehicle 10 was in constant contact with a data source.

Another way to create sets of GPS coordinates for the vehicle 10 to use during autonomous travel would be to travel back along the outgoing path P1. The vehicle 10 could establish outgoing path P1, such as by ascending a hill, to create a trail of GPS coordinates along the way. The autonomous travel path P3 would then comprise a retracing of the outgoing path P1 such that the vehicle 10 would merely follow its own trail to get back to initiation point A. In such a practice, the person 150 might need to turn the vehicle 10 around manually and set it on the outgoing path P1 and then induce the vehicle 10 to start the return trip, retracing the outgoing path P1. Alternatively, the vehicle 10 could automatically find the end of the outgoing path P1 and the beginning of the autonomous travel path P3 by doing a U-turn that would leave the vehicle 10 aligned with the outgoing path P1.

A GPS-only system might be most suitable for wide-open snow slopes, such as those found in the Rocky Mountains, where multiple different travel paths would be acceptable. However, since the accuracy of present lower-cost GPS systems can be in the 5-10 feet range, such systems may not be accurate enough to ensure that a vehicle 10 stays on a narrow path, such as a packed snowmobile trail. In areas with extensive tree coverage, staying on a narrow path might be necessary or even critical. It will also be noted that current GPS signals can be blocked, such as by the evergreen needles, wood, and other material that would be encountered in a wooded area. Thus, even higher-end GPS systems that might exhibit sufficient accuracy to stay on a narrow path could be made inoperable if the GPS signal was attenuated by extensive tree coverage or the like. To a certain extent, however, such data loss or even a slow data rate from a low-end GPS system could be offset by data provided by a compass 18 and a speedometer 20 that could help the system interpolate between acceptable GPS readings.

In each case, impassable terrain could be mapped to ensure the autonomous travel path P3 did not cross difficult terrain that would normally be avoided by a driver. Alternatively or additionally, the vehicle 10 could be equipped with enough intelligence and sensing equipment for obstacle avoidance.

A GPS-enabled system could make use of existing geographic information system (GIS) frameworks. The combination of GIS maps with a known location determined by GPS could allow the vehicle 10 to have access to information concerning the topology of the environment in question. Other information related to structures, tree cover, and the like could be used to allow the rider 10 to plan and execute trips. For example, the vehicle 10 could automatically find a path from a first point to a second point.

GIS information could be downloaded beforehand or in real time as needed via a wireless communications link 22 and then processed by a computer system 24, which could be disposed on the vehicle 10. Alternatively, the combining and use of GPS and GIS data could occur on a separate computing device 25 such as a PC or a remote server and uploaded to the vehicle 10 via communications link 22, such as an RS-232 connection, USB connection, or wireless link employing Bluetooth, IEEE 802.11, or other wireless technology. Data transfer between the computer system 24 of the vehicle 10 and the remote system 50 could also be done via a data storage module 26, such as CompactFlash or other removable-media technology.

The combined set of GPS and GIS data could enable a user, whether the rider 150, an administrator, or a combination thereof, to design personal ski-slope paths, to track vertical feet skied, and to track where there might be untracked snow still left after a storm. These steps could be done using the computer system 24 of the vehicle 10 or an associated remote computing device 25. It will be appreciated, of course, that the schematic depiction of FIG. 2 is merely illustrative and that the various components could be combined in function. Further, additional componentry could be incorporated.

Radio Frequency Identification (RFID) Markers

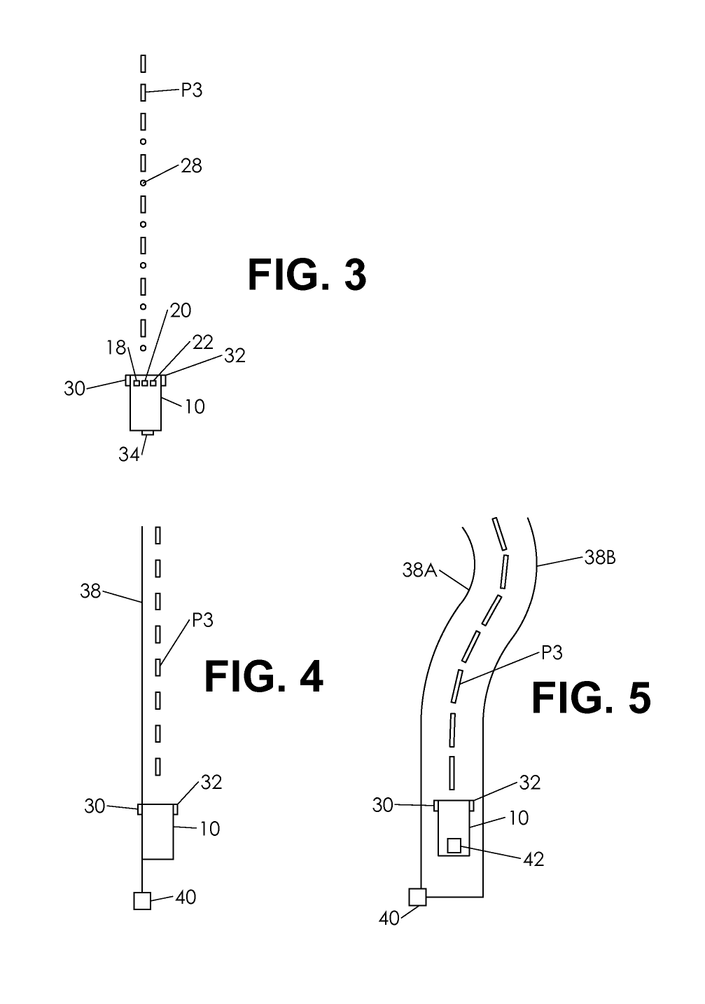

An alternative method for autonomous travel would be to create a physical, sensor-embedded trail that could be followed by the vehicle 10. Such a trail could be laid out to avoid obstacles and difficult terrain. As shown in FIG. 3, the trail could be constructed using sensing elements, such as RFID tags 28. As they can be passive or run off of long-lasting batteries, are ruggedized for outdoor use, and can be sensed from a long enough distance to allow the vehicle 10 to modify its course when traveling at a moderate rate of speed, they would be suitable for this type of application. The sensors 28 could be laid on the ground or mounted on trees or above the ground in some other manner to keep them accessible and out of the snow.

Using one or multiple readers 30, 32, and 34 placed around the vehicle 10, the vehicle 10 could triangulate its position relative to a tag 28 once it got close enough to read the signals by comparing signal strengths between the multiple readers 30, 32, and 34. Alternatively, two or more RFID tags 28 could be read at once by one or more readers 30, 32, and 34 on the vehicle 10 to triangulate a position. Information in the RFID tag 28 could tell the vehicle 10 where on the return path it is.

While some RFID tags 28 have a range of 16 feet, the distance between tags 28 could be greater than the range of the tags 28. This could be result if the tags 28 were merely be used to recalibrate a course that otherwise was directed by other means. Active RFID tags 28 could also be used, which can provide a range upwards of 75 feet. Active RFID tags 28 are usually electrically powered devices that broadcast their ID without the need for an external power-source. Most are battery-powered with life spans being as long as 10-years. Others can have rechargeable batteries that are charged via solar panels or via thermoelectric generators whereby changes in ambient temperature cause physical changes in materials-properties that generate small amounts of voltage. For instance, if the system employed a compass 18, speedometer 20, and timer 36, it could plot a course using “dead reckoning” after registering its position at a known RFID tag 28. The vehicle 10 could then re-compute its location each time it passed a tag 28 and set a new course for the next tag 28 accordingly.

Radio Enabled Wires

An alternative method would be to employ technology similar to that used by the INVISIBLE FENCE™ product wherein wire is disposed, typically underground, to establish an area within which an animal is to be contained. A controller sends two radio signals through the wire with both getting picked up by a dog collar containing a battery. The stronger signal gets picked up further from the wire and causes an audio warning signal to be issued to the dog. The weaker signal gets picked when the dog gets closer to the wire and causes an electrical jolt to the dog's neck. The low-frequency signal can penetrate snow cover and several inches of dirt while being low in installation cost and being able to operate over large distances.

This technology could be adapted to a vehicle 10 under the present invention. As shown in FIG. 4, a wire 38 would be laid, buried, or strung either on or beside the trail on which the PSL is to return. Two sensors 30 and 32, or signal receivers, placed on the vehicle 10 as far apart as possible in the axis perpendicular to the vehicle's line of travel could measure relative signal strengths to give a reading regarding the relative distance of the vehicle 10 from the wire 38. Alternatively, as in FIG. 5, two wires 38A and 38B could be used, each with a different signal, to get the same PSL-relative-to-the-wire position information.

At least three methods of navigation could be used in a wired-based system, although multiple means could be used on a given trip.

The first, a straddle-the-wire approach, would attempt to keep the vehicle 10 over the wire 38 and would therefore require that the wire 38 be laid on the ground so the vehicle 10 could drive over it. The vehicle 10 would continuously monitor the signal strength in its two sensors 30 and 32 and would navigate seeking to keep the two signals constant. When the left side sensor 30 signal strength increases and the right side sensor 32 signal strength weakens, the vehicle 10 would know that it starting to veer to the right but that the wire 38 was still between the two sensors 30 and 32. When the left side signal declines while still remaining stronger than the right side signal, then the vehicle 10 would know that it was now to the right of the wire 38 and moving away from it.

Alternatively, the vehicle 10 could employ a travel-beside-the-wire approach to navigation where the wire 38 can for example be laid out or buried to a side of a trail. In this mode, as in the straddle-the-wire mode, the system would continuously monitor and compare the relative signal strengths of the two sensors 30 and 32 in various ways to see where the vehicle 10 is relative to the wire 38. The further from the wire 38, the more the two signals from the sensors 30 and 32 would be similar. When the difference in relative signal strengths is in a predetermined range, the vehicle 10 can be confirmed to be in a correct position relative to the wire 38.

A third method of control could be a between-two-wires method. In this approach, a signal-carrying wire 38 would be laid or buried on each side of the trail and the vehicle 10 could be configured with just one sensor 30. The 30 would attempt to keep the signals in the sensor or sensors the same ensuring that the vehicle 10 is approximately in the middle of two wires 38A and 38B. In such a wire layout, leading and return wires could be run alongside the trail to form a loop. Lobes in the loop could form branches in the trail.

As the signal might be attenuated as the distance from the transmitter 40 increases, the system would need to compensate for the resulting lateral difference in signal strength as it attempts to keep the vehicle 10 in the middle of the trail. Other signal-strength issues might involve reduced signal due to moisture, snow cover, or battery-drain. One possible compensation method could involve a “calibration” run wherein the user would manually drive the vehicle 10 down the autonomous travel path P3 while the system records any anomalous data. Such data could then be used on any unattended descent to improve system performance.

As exemplified in FIG. 5, under any wire-based system, an accelerometer 42 measuring lateral movements could also be employed to assist in determining vehicular direction and acceleration relative to the wire 38.

A wire-based trail could also have a signaling means to impart absolute location information to the vehicle 10. This location data would also be useful for other purposes such as programming mid-trip stops or taking a fork in the trail to allow the person 150 to rendezvous at one of several possible specified locations. It would be possible to embed data in the wire 38 in one of several ways. Such signals could be generated by shielding small sections of the wire 38 in a coded pattern thus interfering with the signal in a purposeful fashion. Loops in the wire 38 might produce discernable changes in signal strength that could also be detected. Other electrical components could be attached to the wire 38, drawing energy from the wire 38 and then emitting a different type of signal that could be received by the sensors 30 and 32. Alternatively, RFID chips could be used to store location information, although such a system would require additional readers. It could also be possible to use transreflectometry to determine the length of wire 38 in the loop. In transreflectometry pulses are sent along the wire 38 in each direction, and the timing of the arrival of the pulses and the shape of the pulse as reflected off of various impedances in the wire 38 are measured. This allows one to determine the length of a strand of wire.

In this case, we would have two lengths, one heading in each direction from the vehicle 10 back to the base transmitter 40. If the length of the wire 38 is a known distance and if transreflectometry indicates the distance in one or both directions, then one can know how far along the path the vehicle 10 has traveled. The vehicle 10 could also employ a heartbeat-type system wherein pulses are sent out on a regular and known basis. The vehicle 10 could receive the pulses and analyze the received signal to determine what type of signal degradation has occurred. The degradation can be mapped to distance traveled along a wire 38. Signals sent from both ends of the loop could be analyzed such that one could determine an absolute and relative measure of travel along the wire 38.

A preferred trail system will have forks since there might be multiple desirable ways to descend. As a result, the vehicle 10 would need to be programmed to detect forks in the road and to turn one way or the other. One way to detect a fork would be if trails had separate wiring loops and different signals that could be detected by the sensors 30 and 32 as the vehicle 10 got close to the fork. The vehicle 10 would then know to turn towards that signal when received. Alternatively, if absolute positioning data were available via any of the means described above, then the vehicle 10 would merely turn once the appropriate positioning signal was received. Such forks could also be deduced via a time and velocity calculation assuming a known starting point. Forks could also be triggered by placing RFID tags along the wire 38 to indicate when the vehicle 10 should start looking for a new loop or a lobe in a single-wire forked system. Such a warning could be enabled via an RFID device placed at the right location that would give the vehicle the needed time to make the turn, much the same way that a street sign might warn of an upcoming intersection.

Visual Recognition

One simple use of visual recognition technology to stay on the desired autonomous travel path P3 would be to use cameras and visual detection software to try to recognize the path P3 itself. For example, a packed snow trail would often have unique and identifiable characteristics, such as edges caused by packing the snow or a texture caused by the tires or treads of the vehicle 10 going over the snow. The vehicle 10 could have an attachment that actually creates intentional visual markers or footprints.

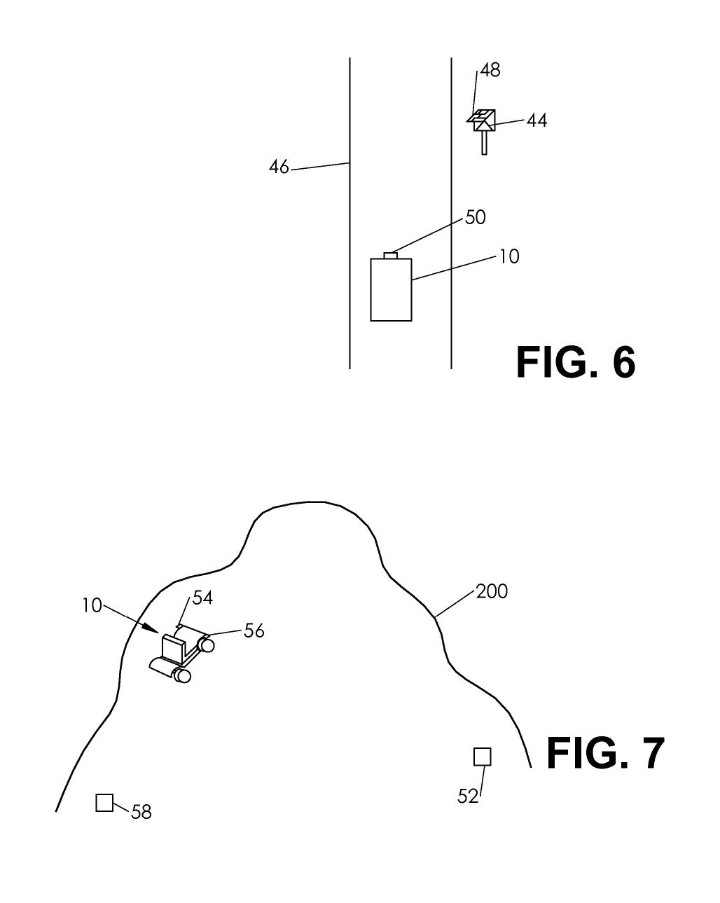

Another method of navigating the terrain would be for the vehicle 10 to use cameras and optical recognition software to find its way down, much in the way that people do. One example of such an embodiment is depicted schematically in FIG. 6, this would entail placing a standard visual marker 44 on the side of the trail 46 that could easily recognized by software. Such a sign might be under a small cover 48 so that snow does not obscure the image. Cameras 50, which can be still cameras shooting consecutive shots or a video camera, on the vehicle 10 can view the visual marker 44 as it is passed and can in certain practices of the invention compare the actual image size to what size the image should be if the vehicle 10 is properly traveling along the trail 46. With this, a sense of distance from the visual marker 44 could be achieved. The system could also deduce the angle between the vehicle 10 and the visual marker 44 by noting its aspect ratio. Such distance and angle information could be sufficient to establish a position relative to the visual marker 44 and the trail 46 in general.

The system could also ascertain what direction the vehicle 10 is traveling as it passes the visual marker 44. In one example, this could be done where the visual marker 44 has a bright or visually recognizable flat surface or tab that faces perpendicularly to the trail 46. As the vehicle 10 passes by, a perpendicularly mounted camera 50 would see that the apparent width of the visual marker 44 get narrower as it approached until only the profile of the visual marker 44 would be apparent. If the visual marker 44 never narrowed to that extent or did not narrow as expected, the system would know that the vehicle 10 was headed at an angle as it passed the visual marker 44.

With enough advances in optical recognition and camera technology, the vehicle 10 could be trained to go trail-less. That is, to travel anywhere it had been “trained” to travel while it or a previous vehicle had been ridden. For example, a camera-equipped vehicle 10 could be driven along routes of allowed travel. The vehicle 10 would record objects in its field of view as it traveled. Later when trying to retrace its steps, it would isolate images and compare their sizes, locations, and aspect ratios recorded in the training run to those in the subsequent run and make adaptations in the route as necessary.

The system could use optical-flow as an odometry feedback system. This would provide a very good idea of how fast and in what direction the vehicular platform is moving. Optical flow can provide data in six degrees of motion, namely x, y, z, and yaw, pitch, and roll. This is similar to the way that humans determine rate of movement based of how fast things pass him or her. An example of such would be a so-called ‘warp-speed’ scenario where the stars form streaks in certain directions. The directions are indicative of various degrees of motion. Optical-flow provides a measure of feedback that is better than encoders, though comparable to accelerometers, in that the feedback is based on actual movement of the platform and not based on what the platform thinks it is doing. Additional processing could be done to perform tasks like following the user, or following the trail that was used to get up the mountain.

Deductive (Dead) Reckoning

Embodiments of the vehicle 10 could employ dead-reckoning, a relatively simple approach to navigating a mobile platform, wherein one plots out a prospective course of travel in terms of distances and directions to be traveled. Determining distance traveled is most commonly done by having encoder feedback on the device, in this case the vehicle 10, such that the number of revolutions of the drive train, wheel, or snowmobile track would be known. Each tick of the encoder corresponds to a discrete hypothetical unit of distance traveled, assuming that the vehicle 10 is in an ideal environment with zero slippage. An encoder would also be placed on the steering arrangement of the vehicle 10 so that the heading of the vehicle 10 could be known. Alternatively, a compass 18 could be used to determine heading. Using such methods, the vehicle 10 could navigate employing a very simple and low-cost method.

This method is usually only suitable for traveling short distances, particularly when under adverse traction conditions. Since the feedback from the encoders only indicates how far and in what direction the vehicle 10 would have moved under ideal traveling conditions assuming no wheel slippage when accelerating and no skidding when decelerating, the distance and direction of travel as indicated by the encoders can vary from actual. When the vehicle 10 is skidding or spinning it wheels or tread, the encoders would increment the revolutions of the drive train or wheels but not actually move the vehicle 10. The further the vehicle 10 travels, the larger these variations due to traction issues, as well as errors caused by mis-calibration of the measuring instruments, are likely to be.

To compensate for these errors and thus to increase the accuracy and usable range of dead-reckoning, additional sensors, such as accelerometers could be placed on the vehicle 10. These additional sensors would help correct for errors in dead-reckoning by noting the lack of apparent movement of the vehicle 10 as determined, for example, when the accelerometer 42 fails to report expected accelerations, or decelerations in the case of a skid when the encoders are reporting increases in tire or tread rotation or turning actions of a certain amplitude.

The vehicle 10 could use dead-reckoning in several ways. First, it could be used as a way to supplement other navigation means. For instance, if a system were temporarily inoperable due to the presence of tree-cover, dead-reckoning could take over, putting the vehicle 10 on an approximate course until GPS is again available. This is an optimal example of when sensor-fusion techniques, such as Kalman filters, would come into play. In another example, a user could drive the vehicle 10 away from the wire-course once at the top of the hill 200 to start from a fresh spot, then “point” the vehicle 10 toward the wire-course allowing dead reckoning to retrace the path that taken after leaving the wire trail. In a third example, the vehicle 10 could track distances and directions that were traveled going to a destination and then the reverse course could be followed to descend with adjustments for error introduced by one leg of the journey being uphill and one being downhill.

Homing-Beacon Approach

Another approach is to use a homing beacon where an RF, IR, sonic, or similar transmitter 52 would be placed at the bottom of the slope 200. The vehicle 10 would be equipped with two or more receivers 54 and 56 spaced a minimum, and known, distance apart. The receivers 54 and 56 would be able to determine the direction of the transmitter 52 by triangulating the source of the signals being received by the multiple receivers 54 and 56. The vehicle 10 when directed would then try to stay oriented towards the direction of the transmitter 52 as it traveled and by this approach make its way down the slope 200 to a desired destination. The orientation would be determined by comparing the signal strengths of two receivers 54 and 56 on the vehicle 10. If the signal strength of the left receiver 54 is larger than the right receiver 56, then it is assumed that the vehicle 10 is pointing too far to the right of the homing beacon 52, and that it should start steering more to the left. The opposite is true if the strength of the right receiver 56 is stronger than that of the left receiver 54.

To determine when to stop, the strength of the signal could be measured, and, once it reaches a certain strength, the vehicle 10 could slow or stop. Alternatively, a second, low-power, frequency could be emitted by the transmitter 52 such that the vehicle 10 would know to stop once it had successfully detected this second frequency.

A second approach to beacon-triangulation would be to position two or more emitters 52 and 58 at fixed locations, located a minimum, known, distance apart, each having a distinguishing signal able to be received by the vehicle 10. If the distance between the emitters 52 and 58 is known, then the relative position of the vehicle 10 can be determined based on the signal strength received by receiver 54. If the vehicle 10 has two receivers 54 and 56, then it can further determine distance and angle from each emitter 52 and 58.

Note that the emitters 52 and 58 and receivers 54 and 56 could be positioned on either the vehicle 10 or on the stationary locations, although if the position calculation were done away from the vehicle 10, the result would need to be communicated back to the vehicle 10. Such an approach would work with very wide-open slopes and where the path from the top to bottom was unobstructed by trees, rocks, and impassable terrain.

Passenger Following

Under another alternative, the vehicle 10 could follow the person 150 down the hill, wherever he or she may be going (“Follow Me”). This approach has the advantage of allowing the vehicle 10 to alter its course as the skier 150 makes spontaneous decisions. A further advantage is that the skier 150 can lead the vehicle 10 down the hill 200 in a safe fashion, avoiding rocks, trees, and other obstacles. This method could be supplemented with a means for determining position, such as the GPS or dead-reckoning arrangements described previously. Such positional information could then be used to retrieve additional data regarding obstacles, steep slopes, and other obstacles around which the skier 150 might be maneuvering around but which might be a challenge for the vehicle 10. Thus, the “Follow-Me” approach provides the overall path for the vehicle 10, while other data inputs provide the “micro-information” needed to make the trip safe and efficient. Obstacles could also be deduced as they are approached using some sort of active detection means, such as visual recognition as previously discussed.

Several systems could be used to implement the “Follow-Me” approach. Most simply, the skier 10 could be equipped with GPS equipment, data from which would be communicated to the vehicle 10. Methods discussed in the beacon approach could be used with the skier 150 acting as the beacon. This means would be supplemented with information concerning the distance between the vehicle 10 and the skier 150, such as a measure of signal strength to approximate distance. When the distance reaches a minimum, presumably because the skier 150 has stopped, the vehicle 10 would slow and come to a stop. Should the skier 150 resume, the minimum distance would be exceeded and the vehicle 10 would proceed. Finally, visual recognition or RFID sensing could provide the data needed for the vehicle 10 to follow the skier 150. An alternative or additional approach could use an IR-camera, a thermal-fingerprint, or some other biometric technique to identify the person 150.

Human-Guided

The vehicle 10 could also maneuver autonomously via some sort of joystick or other form of direct control. Such a joystick could signal acceleration/deceleration commands and direction of travel information. Such a method could be a straightforward and highly controlled means for guiding the vehicle 10. Where the user can see the vehicle 10, the speed of the vehicle 10 might be higher. To give the user better visibility regarding the path being taken, the vehicle 10 could be equipped with a video or other camera system 50 that could transmit real-time video of the path in front of the vehicle 10 to the user of the control device thus allowing for more efficient direct-control guidance.

General Navigation Issues

More than one navigation system may be built into a given vehicle 10. Thus, a vehicle 10 might be equipped with a trail-guided system and joystick control. The former might be used on larger hills with permanent trails while joystick control could be used on, for example, a local sledding hill. Two means might be used on the same slope. For instance, a user might veer off the trail and use the “Follow Me” method to have the vehicle 10 follow.

Sensors in the vehicle 10 could be used to gather data regarding the tilt of the vehicle 10 in each appropriate dimension. This information could be conveyed to the remote driver via graphic displays, text, or even via force feedback on the joystick or other handheld control. This could be combined with the aforementioned GPS and GIS data to create a graphical representation of the vehicle 10 in a rendered representation of the vehicle 10 and terrain on the handheld display device.

The aforementioned tilt data is information that could be useful in any of the navigation means described above. As snow conditions can change rapidly, such tilt information could convey information such as the fact that a snow drift is developing lower down the autonomous travel path P3 where the user might not be able to see. This information could be used to modify or abort the return trip, or be conveyed to the rider 10 upon rendezvous.

Certain methods of navigation could require special thought in laying out the course. RFID tags 28 that could be supplied with the vehicle 10 could be tagged in a numeric sequence such that the vehicle 10 knows to follow them in a certain order. They could also be defined to have special meanings, such as places to fork a certain direction, or places to slow down or speed up. These meanings could also be applied to other navigational methods such as GPS or visual navigation where specific location coordinates could be associated with certain actions.

Taking a snowmobile or other vehicle 10 up a hill or mountain 200 after a snowfall could present challenges if the snow was too deep or hard to drive through. To address this issue, the trail could be packed by a sno-cat of the type that typically pack snowmobile trails, or a road could even be plowed to get the vehicle up the slope. Once on top, packing the automated trail down would be easier and could be down with a rider 150 on the vehicle 10. It would be preferred, however, to avoid the need to bring in a sno-cat or plow.

One solution to the problem could be to leave the vehicle 10 at the top of the trail before a storm and direct it to come down after the storm. To do this, the skier 150 would leave the vehicle 10 at the top at the beginning the last run. The vehicle 10 would be equipped with a remote starter kit of the type used in cars. It could also rest under a shelter so that it would not be encased in snow or ice. The track or wheels could be suspended above the ground so that the treads didn't freeze to the ground, but suspended in such a way, for instance on wooden rails, so that when the gas was applied the vehicle 10 could move forward. The signal to start the vehicle 10 could be a version of the signal used to provide joystick control, thus eliminating the need for another electronic subsystem. The end result is that the user can command the vehicle 10 to “come to me” with the trail getting packed as a result.

Such a “come to me” feature as just described could also be used if the skier 150 failed to meet the vehicle 10 at the correct rendezvous. The vehicle 10 could then be signaled to come down the hill to meet the skier 150. Among the many other non-skiing applications would be the instance of a boy getting off a bus and calling for his ATV 10 to come down and get him.

Interface and User Controls

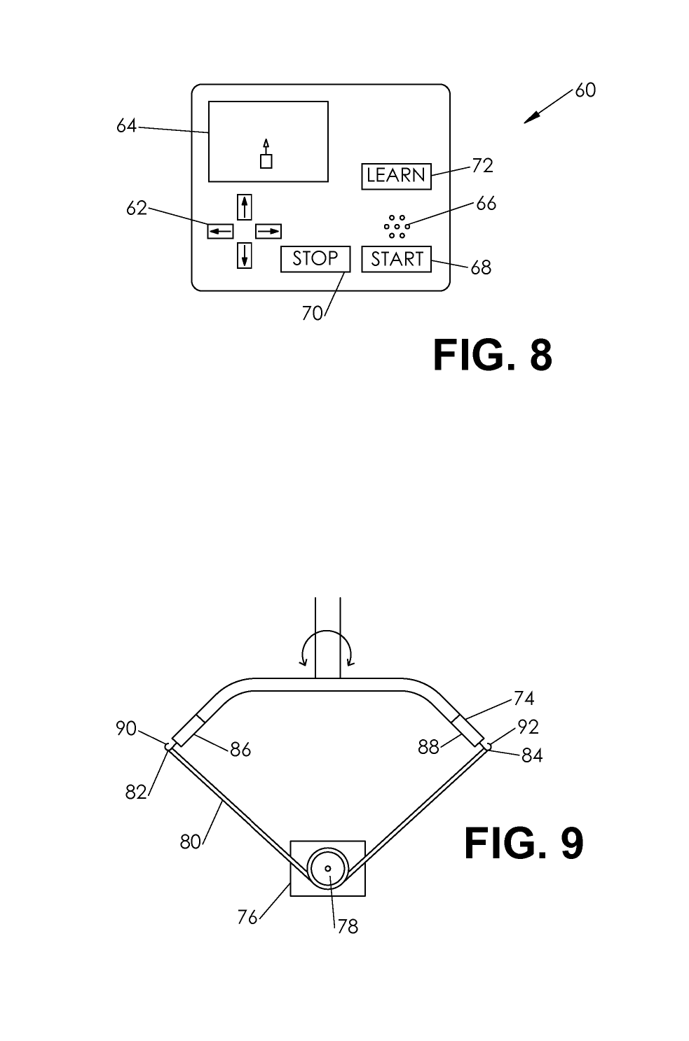

As shown in FIG. 8, the user interface 60 for the system would comprise at a minimum means to give instructions to the vehicle 10. The user interface 60 could be fixed on the vehicle 10, removable from the vehicle 10 for enabling portability, or physically separate from the vehicle 10. Such input means could range from one or more simple buttons 62 to a touch screen display 64 or even a voice input microphone 66. The display 64 can comprise a rugged LCD display designed for outdoor use to inform the user of the location of the vehicle 10, rendezvous options that might be available from that location, the location and number of learned waypoints, data from the last trip, information from a dynamic path-planning system that may include GIS and GPS data and the like. Where the display 64 comprises a touch screen laid over an LCD screen or the like, the user could define routes by tracing on the screen, select which route to take, and select from other menu options.

The user interface 60 for the vehicle 10 could offer a means, such as a button 68, for the user to direct the vehicle 10 to begin its descent. The user could potentially also select routes by which to descend, assuming that multiple routes and, additionally or alternatively, rendezvous points were available. Other inputs might decrease the return speed in case conditions were deteriorating or to provide other information to the vehicle 10 to assist in the return navigation such as locations to slow down at due to current conditions, alternative paths to take to a given rendezvous, or turn on blinkers.

The user interface 60 to the vehicle 10 might also offer means to stop the vehicle 10 on the unattended return down. Such means might constitute a simple “kill” switch 70 on the user interface 60 and, additionally or alternatively, on the vehicle 10. Voice control would be another means to terminate the trip. A further means might comprise a kill switch connected to a cord trailing behind the unit. If the cord was tugged, the vehicle could stop. Emergency kill switches might also be located on the hill 200. In addition, users might carry a means to communicate with the vehicle and stop the vehicle in that manner.

In the case of a vehicle 10 using GPS, visual, or RFID navigational techniques, a means, such as a button 72 disposed on the user interface 60 and/or on the vehicle 10, by which the user could put the vehicle 10 into “learn mode” on the way up the slope. This would instruct the vehicle 10 to start looking for and saving cues that the vehicle 10 could recognize again on the return trip and thus use to navigate down on its return path. This reverse mode is sometimes called retro-transverse. The cues could be GPS target locations, for GPS methods, specific RFID tags for RFID-modes, or visual targets in the case of visually-based navigation. Visual targets could be man-made signage, the tracks that the vehicle 10 has created, or any other visual cues. The interface 60 would also allow for the user to conduct a calibration run, as described above, to ascertain signal characteristics along the trail.

In some situations, the skier 150 may not be able to descend all the way to the bottom of a mountain 200 if there were a “local valley”, an area on the slope where the skier 150 would walk uphill to continue the descent. In this case, the skier 150 could program the vehicle 10 to meet part way down at the bottom of the local valley. At that location, the vehicle 10 could assist the skier 150 out of the local valley with another short uphill ride. Such a short ride might best be facilitated by having a short tow rope or other apparatus that the skier 150 could hold on to while the vehicle 10 traveled out of the local valley. In this manner, skiers 150 would not have to take off their skis 150 to get on the vehicle 10. The interface would provide a means for the skier 150 to restart the trip of the vehicle 10 having completed the rendezvous in the local valley. The skier 150 might be able to initiate this leg of the trip down by activating a control on the tow rope behind the vehicle 10. Such a tow rope might have a means to stop the vehicle 10 and, possibly, an automatic stopping means if the skier 150 let go of the tow rope.

A vehicle 10 could carry 2, 4, or more skiers 150 up a hill with a carry-behind sled being employed for large parties. Such a large party might naturally ski at different rates or take different routes, even if meeting at the same rendezvous point. As such, the vehicle 10 could be allowed to make multiple trips out of the local valley. In this scenario, the interface would allow the skier 150, once out of the local valley, to send the vehicle 10 back down into the valley again to meet another skier 150. A timeout system could perhaps be used so that if no other skier 150 showed up to be taken out of the valley, the vehicle 10 would “loop around” and continue on to the rendezvous. Such a loop around could entail the vehicle 10 leaving the trail and using dead reckoning to get back to it, or there could be loop around built into the trail.

Mechanical

The base vehicle 10, whether it be a snowmobile, an ATV, or another vehicle, upon which the present invention is founded, would need to be retrofitted with means to perform the functions described herein. Alternatively, such means could be designed in and installed by the original equipment manufacturer (“OEM”). Still further, the OEM could design in the ability to have a retrofit kit installed as an after-market product. In certain practices of the invention, a retrofit kit could be designed to fit multiple types of vehicles, such as both a snowmobile and an ATV. The ease with which a kit could be moved from vehicle to vehicle could be another advantageous feature of the invention.

Mechanical elements of the invention would comprise actuators to replace human muscle power to steer, brake, and accelerate the vehicle 10. Such mechanical elements could be controlled by an on-board computer system 24 issuing signals used to drive the vehicle. In addition, travel speed, direction and other data such as tilt could need to be derived from information generated in the vehicle 10, either by the retrofit kit or by the original equipment, and then used by the computer 24 system to drive the vehicle 10.

The retrofit approach could be built around the existing man-machine interfaces. The OEM approach would involve modifications to the low level systems that operate the base vehicle 10. Both approaches are constrained by the fact that the vehicle 10 must be able to be operated by a human rider 150 when it is not in an autonomous mode.

The three main systems that must be automated on the vehicle 10 are steering, braking and acceleration. In the retrofit approach, actuators can mimic the movements that a human operator would normally provide. Because the actuators interface with the base vehicle at a high level, there is a good chance that they will be platform-independent and be able to be installed on many brands of vehicle since the user interface for the base vehicles, including ATVs, is quite similar.

As shown in FIG. 9, steering of the base vehicle 10 could be accomplished by turning a set of handlebars 74 through an arc. In the retrofit approach, the steering of the vehicle 10 is actuated by a bidirectional, high-torque servo motor 76. The servo motor 76 drives a spool 78 that is looped a number of times by a strap, rope, wire, chain, or other elongate flexible member 80. The elongate flexible member 80 has first and second ends that are terminated with spring clips 82 and 84 or other constructs that allow each end of the elongate flexible member 80 to be easily attached to the left and right handles 86 and 88 of the handlebar 74. As FIG. 9 shows, such an attachment might exploit eye hooks 90 and 92 that are threaded into the ends of the handlebars 74. The elongate flexible member 80 could be easily disconnected from the handlebars 74 by a user when the vehicle 10 has come to a stop and is no longer is autonomous mode and recoiled for storage.

When the servo motor 76 is instructed to turn, the elongate flexible member 80 is reeled in on one side of the spool 78 while being fed out on the opposite side. The tension in the elongate flexible member 80 then pulls the handlebars 74 in an arc and steers the vehicle 10. Reversing the direction of rotation of the servo motor 76 produces motion of the handlebars 74 in the opposite direction. Other designs might use two spools-one for an elongate flexible member coupled to each handle 86 and 88.

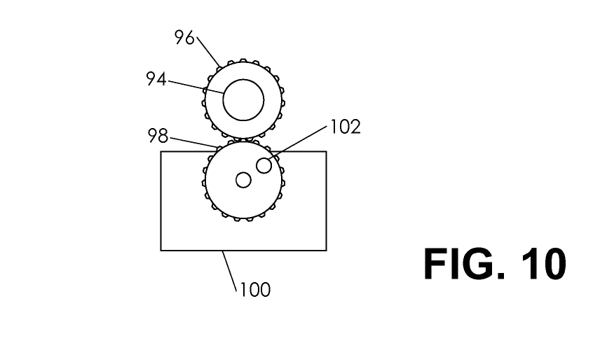

In one potential OEM approach, the actuation of the steering can be done on a lower level thereby doing away with the constraints of the existing man-machine interface and manipulating the steering of the vehicle 10 through a direct mechanical linkage. As shown in FIG. 10, one possible steering arrangement can employ a high-torque servo motor 100 for driving a drive gear 98 that is in driving engagement with a driven gear 96. The driven gear 96 is in driving engagement with the steering column 94 of the vehicle 10 whereby a rotation of the drive gear 98 will induce a rotation of the driven gear 96, a turning of the steering column 94, and thus a steering of the vehicle 10. Alternatively, a drive chain could be employed. Still another mechanism could make use of a linear actuator drivingly engaged with a suspension crank arm of the vehicle 10 in a push-pull manner.

To allow the vehicle 10 to be driven by a human operator, the automated steering system should have a release mechanism to decouple the actuator from the steering assembly. Possible methods include, by way of example, a spring pin or an electro-mechanical solenoid 102 that would be controlled by the user to enable manual steering when the vehicle 10 was not autonomous mode.

Braking of the base vehicle 10 is normally accomplished by either pulling a hand lever or by depressing a foot lever. These high-level actuators typically drive either hydraulic or cable actuated brakes. In one retrofit approach, the braking of the vehicle 10 can be actuated by a bidirectional, high-torque servo motor or linear actuator. The actuator would mimic the action of a human depressing the foot lever or the hand brake. The actuator can be commanded to give fully proportional braking control for smooth operation.

In the OEM version, the braking of the vehicle 10 could be accomplished on a lower level. In a hydraulic braking system, an automated master cylinder could be tied into the system of the vehicle 10 which could then drive the brake pistons. The master cylinder could be automated by a linear actuator or electro-mechanical solenoid. In a cable-actuated braking system, the actuator could drive a secondary brake cable instead of conforming to the existing man-machine braking interface. In either case, braking could be done by either by normal operator action or via command from the sub-system of the present invention built into the vehicle 10.

Acceleration of certain snowmobiles, ATV's, and other vehicles is accomplished by depressing a thumb throttle. The throttle is connected to a spring-loaded butterfly valve in the carburetor. In one retrofit approach, the acceleration of the vehicle 10 can be actuated by a servo motor, which can mimic the movement of a human depressing the thumb throttle by pulling the thumb lever with a cable. Since such a cable would be able to exert force only in a pulling fashion on the throttle, the mechanism can be easily actuated by a human operator when not in autonomous mode. The servo motor is able to provide fully proportional control of the throttle for smooth operation of the PSL.

In one OEM approach, acceleration of the vehicle 10 could be accomplished by actuating the butterfly valve on the carburetor directly with a servo motor under the control of the sub-system of the invention. Such a configuration would still allow an operator to use the normal thumb throttle when the vehicle 10 is not in autonomous mode.

In both approaches, the vehicle 10 could be equipped with an accelerometer 42 as previously described. Information from the accelerometer 42 could be juxtaposed with data from a speedometer 20. If the track or wheels of the vehicle 10 were spinning, the accelerometer 42 would indicate less travel speed than the speedometer 20 such that the computer system 24 could deduce that the vehicle 10 was spinning its tires or wheels. Such a conclusion could be drawn by comparing speedometer data to absolute positioning data from a GPS, RFID, or other similar system. A similar situation might arise if the vehicle 10 were skidding. In either of these cases, the vehicle 10 could address the problem by varying the throttle speed and doing other sorts of actions that a driver might normally take. If it became apparent that the vehicle 10 was truly stuck, or had skidded off the course, it would release the gas throttle and perhaps shut off. A signal could be sent to the operator or others nearby. Information about such a trouble spot might be used to modify the behavior of other units.

Safety

Safety would be of paramount concern in the design of vehicles 10 pursuant to the invention. As such, there are multiple safety features that could be built into the design and implementation of the vehicle 10 to protect users and bystanders as well as protect the vehicle 10 itself from damage. Such features might focus on avoiding uncontrolled contact between a skier 150 and a vehicle 10 or between vehicles 10, avoiding hazards, and controlling speed as a function of terrain or snow conditions. Safety features might include the following:

In the retrofit elongate flexible member version of the vehicle 10, if both ends of the elongate flexible member 80 are not connected to the handlebars 74, the control unit can stop supplying gas to the vehicle 10. Since the elongate flexible member 80 prevents a person from sitting on the vehicle 10, this mechanism will ensure that the automatic unit is turned off the moment someone tries to get on the vehicle 10. In addition, there could be a seat sensor ensuring that if a minimum weight were on the seat, the automatic unit would be disabled.

The control unit of the vehicle 10 will interface with a speedometer 20. If the maximum allowable speed is exceeded, the unit will brake and/or reduce the gas flow to get back below the allowed speed.

The vehicle 10 could be equipped with sensors that could detect the angle of the vehicle 10, in both the direction of travel (thus measuring the steepness of the trail) and the lateral angle (thus measuring any side-tilt of the trail). These tilt measurements could be used to modulate vehicle speed to enhance safety.

The vehicle 10 would have a sense of when it should have gotten to the bottom of the hill based on travel time and the known length of the course. Using this information, the vehicle 10 could be programmed to stop at or near the point that should have been the end of the trip.

If the control unit is not able to determine clearly the path to take (having wandered off the “course” or lost the guiding signal, for instance) it will slow and/or stop the vehicle 10.

When the vehicle 10 does come to a stop for whatever reason, the control unit could be programmed to turn off the ignition.

The vehicle 10 could be equipped with any of several means to detect the proximity of people or even large animals. These methods could include infrared detectors or vision systems that could discern human or animal shapes or alternatively, bodies in motion. Another sensor could be a heartbeat detector, which can detect at a distance the electrical impulses sent to the heart, which has a very low false-positive rate. Microwave radar is yet another option for determining the presence and movement of possible people or animals. Such radar techniques are employed in today's motion detectors for security and automatic doors. Upon sensing the presence of a person, animal, or other vehicle 10 within a certain “danger zone” the vehicle 10 would decelerate or come to a stop. The system would be programmed not to signal a danger when first starting the descent where the user who rode the vehicle 10 up the hill is launching the unit and thus within close range. Only after traveling a preset distance would such proximity sensing instigate a vehicle halt.

Conversely, at the bottom of the hill the vehicles 10 would keep their collision emitters active for a period of time even if the vehicle 10 were turned off. A “parked” signal might also be used to indicate that the vehicle 10 was sitting still. Thus, other vehicles 10 would be able to approach and get closer to the vehicle 10. Alternatively, the approaching vehicle 10 might have absolute location data indicating that it was at the bottom and could slow down but safely approach, and get close to, other vehicles 10.

Despite this, vehicles 10 might continue to stack up further up the trail if vehicles 10 were always taken away from the beginning of the line first. A solution to this problem might involve spreading out the vehicles 10 at the bottom of the trail. Each vehicle 10 could be assigned a “parking space” and when it gets to the end of the trail it would veer off the trail into this space and thus get out of the way of approaching vehicles 10.

Another parking need would arise if a vehicle 10 were commanded to rendezvous partway down a trail on which other vehicles 10 might be expected to be traveling. The vehicle 10 that was stopping could be programmed to pull off the trail at that spot to await its driver allowing other vehicles 10 to pass safely. It would emit its “parked” signal so that other vehicles 10 would know that they could safely pass.

Another proximity detection method would require that things that need to be detected (primarily other vehicles 10 and people in the vicinity) wear or carry electronic systems that emit signals. Such devices might be RFID-type devices, Bluetooth devices, sonic emitters, or other signal emitters that could be used to detect proximity or emit signals that can only be received within a close range. Each vehicle 10 would conversely carry detection equipment able to receive such signals and approximate the distance to the emitting source. Such range detection can be based on signal strength, time of flight if the two devices communicated, phase shifts, or triangulation. If a “tagged” object approached the vehicle 10, the vehicle 10 could slow and if necessary, stop.

In the case of two vehicles 10 approaching each other, it would be desirable for the one that was further “behind” to slow, letting the one that was ahead pull away. This might be done through a means of establishing some absolute location data via RFID, GPS signals, or such means. Furthermore, the emitters might be designed to project in an asymmetric fashion such that the projected signal is front of the vehicle 10 is weaker than the back. If a vehicle 10 slowed down in proportion to the signal strength, the one in back would slow down the most.

Another collision avoidance method would require that each vehicle 10 and all persons on the slope constantly electronically communicate their absolute position to each other. This could be done by equipping all vehicles and people in the restricted area of use with GPS-enabled (or another location-determining system) radio transmitters. Such location information could be broadcast by each vehicle 10 and skier in the area and received by each vehicle 10 in automatic mode. A vehicle 10 in automatic pilot mode would decelerate as such signals indicated the approach and possible collision with another emitting device. The speed of travel of other vehicles and persons in the area would also be determined and the vehicle 10 would be programmed to travel in such a manner to be able to stop in the time it would take another moving object to swerve into its path.

Preferably, a sub-system would also be available to detect the presence of inanimate objects such as fallen trees across the preferred path. Such a system could be based on a sonic, laser, or radar emitter that would project a signal in front of the moving vehicle 10 at a minimum height above the ground. If an object of a minimum size were detected within a minimum distance from the vehicle 10, and determined to be risk to the movement of the vehicle 10, the vehicle 10 would slow down, stop, or take evasive action.

In certain installations, the system could also be aware of oil pressure, speed as reported by the engine, gearshift position, brake level position, seat-belt feedback, and ignition-switch positions. This information could be used to stop the vehicle 10 in the event of an unknown or unexpected state, such as when the gearshift is determined to be in the neutral position, or when the throttle is engaged to a certain position but the forward movement is found to be too much different than the expected movement.

Also on this platform would be an emergency-stopping function. This could be triggered by unexpected conditions, such as Safety Note 11, or in the case that a human bystander decides that the platform should be halted. The emergency-stop could be engaged via push-button on top or side of the vehicle 10, via a remote hand-held interface 60 that the owner or primary operator could carry, or via a trailing line that could be yanked by a user.

Means of Use:

Key Access:

The vehicle design could also address the issue of security—that is, preventing unauthorized people from operating the vehicle 10 when it is unattended, either while in auto-drive mode or once the auto-drive course is finished. One method of ensuring such security is to allow the automatic-drive mode of the vehicle 10 to work without a key. Thus, the vehicle 10 could return to a pre-defined location, without requiring the key. A user who then wished to ride the vehicle 10 manually would need the key to do so.

Another implementation would allow the user to leave the key in the vehicle 10 while in auto-drive mode. For someone to manually operate the unit, a PIN or similar password access would be required before the vehicle 10 would relinquish control to a manual operator without the user being there.

Slope and User Permissions

Each vehicle 10 could also be programmed to operate on select slopes and trails only. Using GPS data, RFID tag information, or similar data, the vehicle could recognize areas or trails where it was not permitted to traverse. Alternatively, different trails could use pulse codes or different frequencies in their transmitters and such information being used by the vehicle 10 to determine if usage was permitted. The vehicle 10 could provide feedback to the operator that a trail was off limits and or cease to operate in the desired autonomous manner. It would be preferable if such information could be conveyed to the user at the beginning of the uphill trip.

Such permissions might be temporal or permanent. If temporal, then data would be loaded into the vehicle 10 on a periodic basis. Such data would enable the vehicle 10 for certain time periods on certain trails using certain forms of navigation.

By the same token, specific individuals could be required to have permissions to use certain vehicles 10 or certain slopes. This information could be coded into the radio-emitting devices described above. If adequate permissions were not recognized by the vehicle 10 it would not operate when said non-permitted user was in close proximity or on the vehicle 10.

Permissions could also be usage based. That is, after a certain number of uses or runs, the permission would expire. Such usage could be confined to specific time periods.

To avoid the problem of users constructing trails that might be too long, the vehicle 10 might require that a coded RFD device be detected along the wire at given intervals. This would prevent the use of non-coded wire to expand a given trail system.

Robotic Tender Skiff

Per our recent discussion, here is a disclosure for the Robotic Dinghy (RD) invention to be integrated into the snobot disclosure.

The RD would be useful as an improved transportation system in situations where a boat was moored to a buoy. Currently, boat owners who keep their boats moored off-shore, have to bring a dinghy with them to reach their boat, get a ride from someone else who has a dinghy, or swim to the boat. The RD solves these problems.

The RD would be attached to an “electric dock” (ED) that itself was attached to the moored boat. Alternatively, the ED could be connected to the moor itself. Such a docking setup would be designed in such a way that the dinghy would not damage the main boat while being connected to the ED. Ideally, the dinghy would be a small craft made of a soft material, perhaps an inflatable craft, and have a small electric motor. Such electric motor could be recharged via a solar panel or via a connection to the electrical system of the main boat.

The dinghy would have electronic steering and throttle such that its movements could be controlled electronically. Controls for such movements would ideally be via a joystick controlled by the user. The ED would include electronics that would release the dinghy upon receipt of an electronic signal from said joystick or other means.

To make use of the RD, the user would start the electronic motor and receive a signal on the controller that there was adequate power for a trip to shore. The ED would then release the dinghy and the dinghy would be steered to shore by the user using line-of-sight navigation. Alternatively, and in cases where line of sight was not completely feasible, a navigation means based in GPS, dead-reckoning, or image processing could provide the ability to reach the user awaiting transportation on the dock or on shore. The user could override such automatic navigation at any time. The user could then drive the dinghy back to the boat, or it could drive itself it so equipped. The user then could dock the dinghy and begin using the main boat.

Upon returning from the trip, the user would then put the main boat on the mooring and transfer to the dinghy as was normally done before use of the RD. Upon reaching shore, the user would then use the RD's navigation means to return to the ED. The ED would be capable of docking, or coupling with the dinghy mooring when it came within close proximity to the ED. To facilitate the final coupling approach, which might be difficult to do from a distance, the RD would include as a navigation means the ability to home in on a signal emitted from the docking unit. Such a sub-system would be similar to the Pololu® IR beacon (http://www.pololu.com/products/pololu/0701/). Such homing signal could be activated via a proximity signal emitted by the dinghy or via a signal given by the user. Alternatively, the docking unit could be continuously “pinging” the dinghy to see if it was range whenever it wasn't docked.

Parking Lot Robot

The PLR would be useful as an improved transportation system in situations where an “asymmetric” or two-part trip is involved. An example of an asymmetric trip is one made by a parking lot valet when parking a car. Such a valet often runs on foot to the parking space where he left your car and then drives it back. Because half of the round trip is on foot, it limits the flexibility as to where the valets can park cars.

A two-part trip is one where each part of one leg of the trip uses a different mode of transportation. For instance, one might drive to a stadium parking lot and then walk a long distance to the stadium. Someone might walk to a taxi stand then get a cab or jump on the subway.

Segway® brand personal riding vehicles (“Segways®”) were developed to provide an alternative to walking. As they can travel at a rate of 14 mph or more, they provide an alternative to a fast run without the normal fatigue factor. One of the limitations in the market for Segways® is many of the times when walking could be replaced by riding a Segway®, an asymmetrical or two-part trip is involved. As a result, there is no way to bring the Segway® back to where it started.

The purpose of PLR invention is to provide a means for the Segway® to be used in an asymmetrical or two-part trip. For instance, in the case of the valet car park a Segway® would ridden by the valet to the parked car and PLR would follow the car back to the “home base” where it could be used on the next trip. Each PLR would need to be able to drive itself under electronic control. This technology exists today as robotic Segways® have been developed to play soccer, for instance, using a joystick. The PLR would replace joystick control with control inputs provided by a vehicle that it was following. Two approaches could be used for allowing the Segway® to return back to a predetermined location.

The first method of providing control input would involve a Virtual Hitch (VH). The VH would allow the robotically controlled Segway® to follow a car equipped with a VH. The valet would place the Segway® right behind the car and activate the VH with a switch. This would put the Segway® into autopilot mode where it would be programmed to travel a specific distance behind the car with the MP attached to its back.

In addition to the robotic components, the VH would include a magnetic pod (MP) that would easily attach (and detach) to the vehicle being followed. One or more sensors, perhaps laterally spaced if more than one was used, would be attached to the Segway® itself. The MP would be in radio, light, or audio contact with the Segway®'s sensors, which could then discern the distance and lateral orientation of the car in relation to the Segway®. Using the same sort of algorithms that cars use that have dynamic cruise control (allowing them to follow the car ahead by the same distance) the Segway® would follow the car to which it was hitched. Such technology is currently employed in the Pololu® beacon, a product that lets robots follow each other (http://www.pololu.com/products/pololu/0001/).

An alternative, mechanical implementation of the VH, a Semi-Virtual Hitch (SVH), would rely on physical attachments between the MP(s) and the Segway®. These attachments could be merely tethers that could connect the Segway® with the vehicle being followed. Such a tether, when pulled, could cause the Segway® to lean forward, thus increasing its speed due to the fact that such forward lean controls the speed of a Segway®. Alternatively, a tension measuring device could provide information to generate an electronic signal to the Segway® to increase its speed.

Directional control could also be physically generated by using a tether. Use of more than one tether, for instance, one on each handle of the Segway® would give the tether more directional force. Alternatively, a tether with a sensing mechanism for detecting the direction of the tether relative to that of the Segway® could provide the needed orientation information to generate an electronic signal to the Segway® to turn in the needed direction.

The VH could be used in any situation where a person had to go some distance to fetch a vehicle—or conversely, had to drop one off and walk back. In either case, the user would ride the Segway® on one leg of the trip and use the vehicle, with the Segway® following behind, for the other half of the journey. Large auto dealers, large parking lots of all sorts, and industrial settings might be venues that could make use of the VH. By being able to dramatically increase the productivity of valet car parks, the use of valets could expand. Some parking garages might convert to all valet service, which would have the ancillary benefit of allowing the double parking of cars thus greatly increasing the capacity of the lot at the same as increasing revenue per customer. Consumers would benefit by not having to search for a space and then walking through the whole garage to get where they needed to go.

In the case of a two-part trip, the robotic controls would be used to return the base while the user completed the trip by another means. In this way, the Segway® would not just stay parked awaiting the return of the user. It could return to a “home base” or another location, to perform another task. Such a system would avoid the security risk of leaving the Segway® when the user left it, and avoid under-utilization of the Segway® if somebody else could be using it in the meantime.

In indoor environments, the robotic mechanism could be able to precisely record its trip—noting time, velocity and all turns. When asked to go back, it would merely, reverse the trip by doing the opposite. This “backpacking” approach might be useful on factory floors, office spaces, etc, where the environment doesn't change often and traction is perfect (and thus speed and turning information is precise). To allow a user to “retrieve” a Segway® (for instance, when the user needed the Segway® to complete the Segway® part of a two-part trip), a radio connection could be established that could call the robotic Segway® and have it repeat the trip it did earlier or follow some other pre-defined path. Perhaps the Segway® would be stored in a common area and one could be pulled from inventory or a corral of Segways®. This might require it to obtain the trip information stored on another. Eventually, in this indoor environment, known trips could be memorized and cataloged. A location could be punched in an input device and the Segway® would travel that set path. Some means to recalibrate location might be needed—and this could be done the driver at one end of the trip and a person at the corral at the other. Alternatively, another means could be used to identify calibration locations at one end of the trip or at other points along the way.

A practical method to implement outdoor vehicle control on known paths would to use a wire-control technology. It meets the needs of being cheap, very precise, weather-proof, and having an long range. Other technologies could also work, including those using RFID sensors. These would have the advantage of not needing to dig up pavement but finding places to place the sensors might be a challenge as well.

From the foregoing, it will be clear that the present invention has been shown and described with reference to certain preferred embodiments that merely exemplify the broader invention revealed herein. Certainly, those skilled in the art can conceive of alternative embodiments. For instance, those with the major features of the invention in mind could craft embodiments that incorporate one or more major features while not incorporating all aspects of the foregoing exemplary embodiments.

With this in mind, the claims that follow will define the scope of protection to be afforded the invention, and those claims shall be deemed to include equivalent constructions insofar as they do not depart from the spirit and scope of the present invention. Certain of these claims express certain elements as a means for performing a specific function, at times without the recital of structure or material. As the law demands, any such claims shall be construed to cover not only the corresponding structure and material expressly described in the specification but also equivalents thereof.

We claim:

1. A transport system comprising a vehicle driven by a passenger from a first location to a second location and adapted for traveling under track-free self-control either from said second location to a third location or to said first location, absent said passenger.

2. The transport system of claim 1 wherein said third location is said first location.

3. The transport system of claim 2 wherein said vehicle comprises access-denial means preventing driving by unauthorized passengers.

4. The transport system of claim 3 wherein said access-denial means comprises one or more of a pass code specific to said passenger or an operation key.

5. The transport system of claim 2 further comprising said passenger, and wherein said passenger is equipped with identification means and said vehicle is equipped with recognition means for recognizing said identification means and for denying the driving of said vehicle absent said recognition.

6. The transport system of claim 1 wherein said vehicle further comprises vehicle location means for identifying the geographic position of said vehicle.

7. The transport system of claim 6 wherein said vehicle location means comprises one of the Global Positioning System or Radio Frequency Identification.

8. The transport system of claim 7 wherein said first vehicle is an all-terrain vehicle or a snowmobile.

9. The transport system of claim 6 further comprising said passenger, and wherein said passenger comprises passenger location means for identifying the geographic position of said passenger.

10. The transport system of claim 9 wherein said vehicle location means comprises one or more of the Global Positioning System or Radio Frequency Identification.

11. The transport system of claim 10 wherein said first vehicle is an all-terrain vehicle or a snowmobile.

12. The transport system of claim 1 wherein said vehicle further comprises vehicle location control means for controlling the geographic position of said vehicle.

13. The transport system of claim 12 wherein said vehicle location control means comprises one of GPS-based navigation, RFID markers, Dead-Reckoning, radio-enabled wiring, a visual recognition system, a homing beacon, a passenger following system, and human-guided remote control.

14. The transport system of claim 1 wherein said vehicle further comprises vehicle location identification and control means for identifying and controlling the geographic position of said vehicle.

15. The transport system of claim 14 wherein said vehicle is a first vehicle and said system further comprises a second vehicle and said second vehicle comprises second vehicle location identification and control means for identifying and controlling the geographic position of said second vehicle, and wherein said first and second vehicles comprise means employing said vehicle location identification and control means to avoid a collision with each other.

16. The transport system of claim 15 wherein said system further comprises said passenger, and wherein said passenger comprises a passenger location means for identifying the geographic position of said passenger, and wherein said first vehicle comprises means employing said passenger location means for controlling the geographic position of said first vehicle.

17. The transport system of claim 16 wherein said first vehicle is an all terrain vehicle or a snowmobile.

18. The transport system of claim 17 wherein said first vehicle comprises control means for avoiding and circumventing hazards.

19. The transport system of claim 1 wherein said vehicle has autonomy to alter said third location upon recognition of some predetermined conditions.

20. A method of transportation wherein a passenger drives a vehicle from a first location to a second location and said vehicle travels under track-free self control either from said second location to a third location or to said first location, absent said passenger.

21. The method of claim 20 wherein said third location is said first location.

22. The method of claim 21 wherein said vehicle comprises access-denial means preventing driving by unauthorized passengers.

23. The method of claim 22 wherein said access-denial means comprises one or more of a pass code specific to said passenger, or an operation key.

24. The method of claim 23 wherein said passenger is equipped with identification means and said vehicle is equipped with recognition means for recognizing said identification means and for denying the driving of said vehicle absent said recognition.

25. The method of claim 20 wherein said vehicle further comprises vehicle location means for identifying the geographic position of said vehicle.

26. The method of claim 25 wherein said vehicle location means comprises one of the Global Positioning System or Radio Frequency Identification.

27. The method of claim 26 wherein said first vehicle is an all-terrain vehicle or a snowmobile.

28. The method of claim 25 wherein said passenger comprises passenger location means for identifying the geographic position of said passenger.

29. The method of claim 28 wherein said vehicle location means comprises one of the Global Positioning System or Radio Frequency Identification.

30. The method of claim 29 wherein said first vehicle is an all-terrain vehicle or a snowmobile.

31. The method of claim 20 wherein said vehicle further comprises vehicle location control means for controlling the geographic position of said vehicle.

32. The method of claim 31 wherein said vehicle location control means comprises one of GPS-based navigation, RFID markers, Dead-Reckoning, radio-enabled wiring, a visual recognition system, a homing beacon, a passenger following system, and human-guided remote control.

33. The method of claim 20 wherein said vehicle further comprises vehicle location identification and control means for identifying and controlling the geographic position of said vehicle.

34. The method of claim 33 wherein said vehicle is a first vehicle and wherein a second vehicle and said second vehicle comprises second vehicle location identification and control means for identifying and controlling the geographic position of said second vehicle, and wherein said first and second vehicles comprise means employing said vehicle location identification and control means to avoid a collision with each other.

35. The method of claim 34 wherein said passenger comprises a passenger location means for identifying the geographic position of said passenger, and wherein said first vehicle comprises means employing said passenger location means for controlling the geographic position of said first vehicle.

36. The method of claim 35 wherein said first vehicle is an all terrain vehicle or a snowmobile.

37. The method of claim 36 wherein said first vehicle comprises control means for avoiding and circumventing hazards.

38. The method of claim 20 wherein said vehicle has autonomy to alter said third location upon recognition of some predetermined conditions.

39. A transport system comprising a passenger and a vehicle of the type taken from the group including an all-terrain vehicle and a snowmobile, wherein said vehicle is driven by said passenger from a downhill location to an uphill location, and wherein said vehicle then travels under track-free self-control, absent said passenger, from said uphill location to a meeting location, and said passenger travels independently of said vehicle from said uphill location to said meeting location to meet with said vehicle there-at.

40. The transport system of claim 39 further including a ski slope, and wherein said uphill location is atop said ski slope, said meeting location is at a lower altitude on or at the lower terminus of said ski slope, and said passenger travels from said uphill location to said meeting location by skiing down said ski slope.
